(19) United States
(12) Patent Application Publication
(10) Pub. No.: US 2008/0281033 A1
(43) Pub. Date: Nov. 13, 2008

(54) Long fiber reinforced composites

(75) Inventors: Christopher John Brooke Dobbin, Calgary (CA); XiaoChuan Wang, Calgary (CA); Alexei Kazakov, Calgary (CA)

Correspondence Address: Kenneth H. Johnson;Patent Attorney, P.O. Box 630708, Houston, TX, 77263, US

(73) Assignee: NOVA Chemicals (International) S.A.

(21) Appl. No.: 11/435,329

(22) Filed: May 16, 2006

(51) Int. Cl. C08K 3/40

(52) U.S. Cl. 524/494

(57) ABSTRACT

A composite comprising from about 20 to 40 weight % of fiber reinforcing having a nominal length of not less than 1.25 cm, from about 1 to 10 weight % of a polar polymer and from 79 to 50 weight % of a polyolefin prepared using a single site catalyst has improved physical properties over comparable compositions made using polyolefins made using Ziegler Natta catalysts. The composites are suitable in many applications including construction and particularly in making concrete forms.

### FIELD OF THE INVENTION

The present invention relates to polyolefin composites and particularly long fiber reinforced polyolefin composites. The composite comprises:

(i) from 20 to 40 weight % of fibers having a nominal length of at least 1.25 cm;

(ii) from 1 to 10 weight % of a polar polymer as a compatibilizer, preferably a functionalized polyolefin; and

(iii) from 79 to 50 weight % of a polyethylene having a density greater than 0.935 g/cc and an MI from 0.5 to 10 g/10 min, prepared using single site catalysts such as a metallocene, a constrained geometry catalyst, or a bulky heteroatom catalyst (such as a phosphinimine catalyst). The composition may be in the form of a sheet or slab (monolith), or a sandwich structure with a flat face sheet and a reinforcing back optionally with a flat back sheet which may be used as a form to pour concrete.

### BACKGROUND OF THE INVENTION

Wood is a common construction material both in primary construction such as framing elements (e.g. 2×4's) and as a secondary construction element such as forms for pouring concrete (e.g. foundations or basements). Unfortunately wood sheeting is becoming more expensive to purchase and subsequently dispose of as landfill and there is a need for a reliable highly durable substitute for wood particularly for use in secondary construction.

Polymers have long been available and there are numerous suggestions in the patent literature to use polymers to replace wood in the construction industry. One of the more readily commercially available polymers is polyethylene. There are a number of types of polyethylene including high pressure low density polyethylene (the original polyethylene); Ziegler Natta (Ti based) and chromium (Phillips) catalyzed polyethylene (circa 1950's —solution or slurry type); gas phase polymerization (circa 1980's UNIPOL process—Linear low density polyethylene); and more recently single site (metallocene (Exxon)); constrained geometry (Dow); and others (NOVA Chemicals—phosphinimine catalyst). The more recent single site type catalyst provide polymers which are more uniformly structured and may be tailored to a certain extent leading to tougher polymers. However, the single site type polyethylene on its own is not stiff enough to be used as a replacement for wood. Polyolefin needs to be reinforced with long fibers, preferably glass, to increase the structural modulus sufficiently.

Long fiber reinforcement of polymers is known but subject to a number of difficulties. Large parts such as hulls for recreational boating may be prepared by spraying a mold with a mixture of long glass fiber and polymer typically polyester. Unfortunately this is an expensive and time-consuming process. Such a process is not attractive to a low cost wood product to be used for example in concrete forms. The use of injection molding for this purpose is known. However, the screw(s) in the injection molding machine tend to chop up the glass fiber and reduce its length below about a half an inch, reducing the effectiveness of the fiber reinforcement. Additionally, in injection molding the fibers and polymer tend to become preferentially oriented during the molding process so the reinforcement tends to be in the direction transverse to the direction of polymer flow in the mold. Pulltrusion (e.g. pulling fibers through a cross head on an extrusion die) can produce a long glass fiber reinforced composites but the fibers are oriented in the longitudinal axis of the part. There are a number of recent patents by Polk et al. that provide a method for molding long glass fiber parts (e.g. U.S. Pat. Nos. 6,900,547; 6,869,558; and 6,719,551). These patents do not appear to contemplate the polar or functionalized polymers required in the present invention to provide good adhesion between the fiber and the matrix polymer.

WO0031356 A1 (corresponding to European patent application EP 1135564 A1 and Canadian patent application CA 2,352,368) teaches a long glass fiber reinforced polyolefin material which includes maleic anhydride as a coupling agent. The disclosure teaches a hollow laminate structure. The disclosure teaches it is preferable to use recycle material and preferably polypropylene. There is no teaching that a single site polyethylene would provide enhanced properties over conventional Ziegler Natta polymerized polyethylene.

U.S. Pat. No. 5,525,285 issued Jun. 11, 1996 to Matsumoto et al. assigned to Sumitomo Chemical Company teaches a process for molding a long glass fiber reinforced part. The molding process is a compression molding process. The patent fails to teach or suggest the use of a polar polymer in the molded composition.

U.S. patent application 20040261342 published Dec. 30, 2004 in the name of Hatem et al. teaches a form for pouring concrete. The form is a plastic material, which may be reinforced using long glass fiber. The only plastic disclosed in the specification is polypropylene. There is no reference in the specification of a polar polymer, nor is there any disclosure of the ratio of components. The reference does not direct one of the ordinary skill in the art towards the subject matter of the present invention.

The present invention seeks to provide a low cost, durable sheet material, either monolith or sandwich, useful in the construction industry, and particularly useful as a component for a mold for pouring concrete.

### SUMMARY OF THE INVENTION

The present invention provides a polyolefin composition which when formed into a sheet material has a flexural modulus strength in the extrusion flow direction of not less than 650 MPA, as determined by ASTM D 790; an elongation at yield in the extrusion flow direction of not more than 16% as measured by ASTM D 638; a tensile strength at break in the extrusion flow direction of not less than 30 MPA as measured by ASTM D 638; a yield strength (extrusion flow direction) of not lest than 30 MPA as determined by ASTM D 638 comprising:

(i) from 20 to 40 weight % of reinforcing fibers having a nominal length of at least 1.25 cm;

(ii) from 1 to 10 weight % of a polar polymer; and

(iii) from 79 to 50 weight % of a polyethylene having a density greater than 0.935 g/cc and an MI from 0.5 to 10 g/10 min, prepared by polymerizing from 95 to 99.9 weight % of one or more C₂₋₄ alpha olefin monomers and from 0.01 to 5 weight % of one or more C₆₋₈ alpha olefins in the presence of a catalyst of the formula (selected from the group consisting of):

(L)n-M-(Y)ₚ

wherein M is selected from the group consisting of Ti, Zr, and Hf; L is a monoanionic ligand independently selected from the group consisting of cyclopentadienyl-type ligands, and a bulky heteroatom ligand containing not less than five atoms in total of which at least 20%, numerically are carbon atoms and further containing at least one heteroatom selected from the group consisting of boron, nitrogen, oxygen, phosphorus, sulfur and silicon said bulky heteroatom ligand being sigma or pi-bonded to M; Y is independently selected for the group consisting of activatable ligands; n may be from 1 to 3; and p may be from 1 to 3, provided that the sum of n+p equals the valence state of M, and further provided that two L ligands may be bridged, and an activator.

### BRIEF DESCRIPTION OF THE DRAWINGS

FIG. 1 is an electron micrograph (1000×magnification) of a composite made with a single site resin as the matrix and 30 weight % of glass without any polar polymer.

FIG. 2 is an electron micrograph (1000×magnification) of a composite made with a single site resin as the matrix and 30 weight % of glass with 5% of a polar polymer (a polyethylene maleic anhydride graft copolymer).

### DETAILED DESCRIPTION

As used in this patent specification extrusion direction means the predominant direction of flow of the molten composite as it is extruded from the extruder. In some senses it may be considered comparable to a machine direction.

As used in this patent specification Ml means melt index which is I₂ as determined by ASTM D-1238 condition (E) (i.e. grams of polymer extruded under a load of 2.16 kg. at 190° C. through a standard orifice.)

The present inventions relates to long fiber, preferably glass, reinforced olefin polymers, particularly, polyethylene. Preferably the comonomer is selected from the group consisting of hexane and octane, preferably octene. The polymer has a density greater than 0.935 g/cc, preferably from 0.939 to 0.959 g/cc, most preferably from 0.945 to 0.959 g/cc. The polymer generally comprises from 95 to 99.9 weight % of one or more C₂₋₄ alpha olefin monomers and from 0.01 to 5 weight % of one or more C₆₋₈ alpha olefin monomers. Typically the polymer has a melt index (ASTM D1238, 2.16 kg, 190° C.) from 0.5 to 10 g/10 min, preferably from 2 to 8 g/10 min The polymers are prepared by polymerizing in the presence of a catalyst of the formula (selected from the group consisting of):

(L)ₙ-M-(Y)ₚ

wherein M is selected from the group consisting of Ti, Zr, and Hf; L is a monoanionic ligand independently selected from the group consisting of cyclopentadienyl-type ligands, and a bulky heteroatom ligand containing not less than five atoms in total of which at least 20%, numerically are carbon atoms and further containing at least one heteroatom selected from the group consisting of boron, nitrogen, oxygen, phosphorus, sulfur and silicon said bulky heteroatom ligand being sigma or pi-bonded to M; Y is independently selected for the group consisting of activatable ligands; n may be from 1 to 3; and p may be from 1 to 3, provided that the sum of n+p equals the valence state of M, and further provided that two L ligands may be bridged, and an activator.

The polymer is prepared in the presence of a single site catalyst.

In one embodiment, the single site catalyst may be a metallocene type catalyst wherein L is a cyclopentadienyl type ligand and n, may be from 1 to 3, preferably 2.

The cyclopentadienyl-type ligand is a C₅₋₁₃ ligand containing a 5-membered carbon ring having delocalized bonding within the ring and bound to the metal atom (i.e. the active catalyst metal or site) through η⁵ bonds and said ligand being unsubstituted or up to fully substituted with one or more substituents selected from the group consisting of C₁₋₁₀ hydrocarbyl radicals in which hydrocarbyl substituents are unsubstituted or further substituted by one or more substituents selected from the group consisting of a halogen atom and a C₁₋₈ alkyl radical; a halogen atom; a C₁₋₈ alkoxy radical; a C₆₋₁₀ aryl or aryloxy radical; an amido radical which is unsubstituted or substituted by up to two C₁₋₈ alkyl radicals; a phosphido radical which is unsubstituted or substituted by up to two C₁₋₈ alkyl radicals; silyl radicals of the formula —S—(R)₃ wherein each R is independently selected from the group consisting of hydrogen, a C₁₋₈ alkyl or alkoxy radical, and C₆₋₁₀ aryl or aryloxy radicals; and germanyl radicals of the formula Ge—(R)₃ wherein R is as defined above. Preferably the cyclopentadienyl ligand (Cp) is independently selected from the group consisting of a cyclopentadienyl radical, an indenyl radical and a fluorenyl radical.

In the single site type catalyst two cyclopentadienyl ligand may be bridged or joined. If two cyclopentadienyl ligands are bridged or joined together the catalyst may be a constrained geometry catalyst. Non-limiting examples of bridging group include bridging groups containing at least one Group 13 to 16 atom, often referred to a divalent moiety such as but not limited to at least one of a carbon, oxygen, nitrogen, silicon, boron, germanium and tin atom or a combination thereof. Preferably, the bridging group contains a carbon, silicon or germanium atom, most preferably at least one silicon atom or at least one carbon atom. The bridging group may also contain substituent radicals as defined above including halogens.

Some bridging groups include but are not limited to, a di C₁₋₆ alkyl radical (e.g. alkylene radical for example an ethylene bridge), di C₆₋₁₀ aryl radical (e.g. a benzyl radical having two bonding positions available), silicon or germanium radicals substituted by one or more radicals selected from the group consisting of C₁₋₆ alkyl, C₆₋₁₀ aryl, phosphine or amine radical which are unsubstituted or up to fully substituted by one or more C₁₋₆ alkyl or C₆₋₁₀ aryl radicals, or a hydrocarbyl radical such as a C₁₋₆ alkyl radical or a C₆₋₁₀ arylene (e.g. divalent aryl radicals); divalent C₁₋₆ alkoxide radicals (e.g. —CH₂ CHOH CH₂—) and the like.

Exemplary of the silyl species of bridging groups are dimethylsilyl, methylphenylsilyl, diethylsilyl, ethylphenylsilyl, diphenylsilyl bridged compounds. Most preferred of the bridged species are dimethylsilyl, diethylsilyl and methylphenylsilyl bridged compounds.

Exemplary hydrocarbyl radicals for bridging groups include methylene, ethylene, propylene, butylene, phenylene and the like, with methylene being preferred.

Exemplary bridging amides include dimethylamide, diethylamide, methylethylamide, di-t-butylamide, diisopropylamide and the like.

The activatable ligands (Y) may be independently selected from the group consisting of a hydrogen atom; a halogen atom, a C₁₋₁₀ hydrocarbyl radical; a C₁₋₁₀ alkoxy radical; a C₅₋₁₀ aryl oxide radical; each of which said hydrocarbyl, alkoxy, and aryl oxide radicals may be unsubstituted by or further substituted by one or more substituents selected from the group consisting of a halogen atom; a C₁₋₈ alkyl radical; a C₁₋₈ alkoxy radical; a C₆₋₁₀ aryl or aryloxy radical; an amido radical which is unsubstituted or substituted by up to two C₁₋₈ alkyl radicals; and a phosphido radical which is unsubstituted or substituted by up to two C₁₋₈ alkyl radicals. Preferably Y is independently selected from the group consisting of a hydrogen atom, a chlorine atom and a C₁₋₄ alkyl radical.

In one embodiment of the invention the catalyst may contain a bulky heteroatom ligand. The bulky heteroatom ligand is selected from the group consisting of phosphinimine ligands, ketimide ligands, silicon-containing heteroatom ligands, amido ligands, alkoxy ligands, boron heterocyclic ligands and phosphole ligands.

If the catalyst contains one or more bulky heteroatom ligands the catalyst would have the formula:

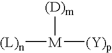

wherein M is a transition metal selected from the group consisting of Ti, Hf and Zr; D is independently a bulky heteroatom ligand (as described below); L is a monoanionic ligand selected from the group consisting of cyclopentadienyl-type ligands; Y is independently selected from the group consisting of activatable ligands; m is 1 or 2; n is 0 or 1; and p is an integer and the sum of m+n+p equals the valence state of M, provided that when m is 2, D may be the same or different bulky heteroatom ligands.

Bulky heteroatom ligands (D) include but are not limited to phosphinimine ligands and ketimide (ketimine) ligands.

In a further embodiment, the catalyst may contain one or two phosphinimine ligands (PI) which are bonded to the metal and the second catalyst has the formula:

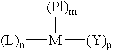

wherein M is a group 4 metal; Pi is a phosphinimine ligand; L is a monoanionic ligand selected from the group consisting of a cyclopentadienyl-type ligand; Y is independently selected from the group consisting of activatable ligands; m is 1 or 2; n is 0 or 1; p is an integer and the sum of m+n+p equals the valence state of M.

The phosphinimine ligand is defined by the formula:

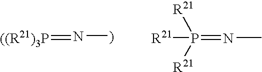

wherein each R²¹ is independently selected from the group consisting of a hydrogen atom; a halogen atom; C₁₋₂₀, preferably C₁₋₁₀ hydrocarbyl radicals which are unsubstituted by or further substituted by a halogen atom; a C₁₋₈ alkoxy radical; a C₆₋₁₀ aryl or aryloxy radical; an amido radical; a silyl radical of the formula:

—Si—(R²²)₃

wherein each R²² is independently selected from the group consisting of hydrogen, a C₁₋₈ alkyl or alkoxy radical, and C₆₋₁₀ aryl or aryloxy radicals; and a germanyl radical of the formula:

—Ge—(R²²)₃

wherein R²² is as defined above.

The preferred phosphinimines are those in which each R²¹ is a hydrocarbyl radical, preferably a C₁₋₆ hydrocarbyl radical.

Suitable phosphinimine catalysts are Group 4 organometallic complexes which contain one phosphinimine ligand (as described above) and one ligand L which is either a cyclopentadienyl-type ligand or a heteroatom ligand.

As used herein, the term “ketimide ligand” refers to a ligand which:

(a) is bonded to the transition metal via a metal-nitrogen atom bond;

(b) has a single substituent on the nitrogen atom (where this single substituent is a carbon atom which is doubly bonded to the N atom); and

(c) has two substituents Sub 1 and Sub 2 (described below) which are bonded to the carbon atom.

Conditions a, b and c are illustrated below:

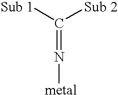

The substituents “Sub 1” and “Sub 2” may be the same or different. Exemplary substituents include hydrocarbyl radicals having from 1 to 20, preferably from 3 to 6, carbon atoms, silyl groups (as described below), amido groups (as described below) and phosphido groups (as described below). For reasons of cost and convenience it is preferred that these substituents both be hydrocarbyls, especially simple alkyls and most preferably tertiary butyl. “Sub 1” and “Sub 2” may be the same or different and can be bonded to each other to form a ring.

Suitable ketimide catalysts are Group 4 organometallic complexes which contain one ketimide ligand (as described above) and one ligand L which is either a cyclopentadienyl-type ligand or a heteroatom ligand.

The term bulky heteroatom ligand (D) is not limited to phosphinimine or ketimide ligands and includes ligands which contain at least one heteroatom selected from the group consisting of boron, nitrogen, oxygen, phosphorus, sulfur and silicon. The heteroatom ligand may be sigma or pi-bonded to the metal. Exemplary heteroatom ligands include silicon-containing heteroatom ligands, amido ligands, alkoxy ligands, boron heterocyclic ligands and phosphole ligands, as all described below.

Silicon containing heteroatom ligands are defined by the formula:

—(Y)SiRₓR_{y}R_{z}

wherein the — denotes a bond to the transition metal and Y is sulfur or oxygen.

The substituents on the Si atom, namely Rₓ, R_{y} and R_{z} are required in order to satisfy the bonding orbital of the Si atom. The use of any particular substituent Rₓ, R_{y} or R_{z} is not especially important to the success of this invention. It is preferred that each of Rₓ, R_{y} and R_{z} is a C₁₋₂ hydrocarbyl group (i.e. methyl or ethyl) simply because such materials are readily synthesized from commercially available materials.

The term “amido” is meant to convey its broad, conventional meaning. Thus, these ligands are characterized by (a) a metal-nitrogen bond; and (b) the presence of two substituents (which are typically simple alkyl or silyl groups) on the nitrogen atom.

The terms “alkoxy” and “aryloxy” is also intended to convey its conventional meaning. Thus, these ligands are characterized by (a) a metal oxygen bond; and (b) the presence of a hydrocarbyl group bonded to the oxygen atom. The hydrocarbyl group may be a C₁₋₁₀ straight chained, branched or cyclic alkyl radical or a C₆₋₁₃ aromatic radical where the radicals are unsubstituted or further substituted by one or more C₁₋₄ alkyl radicals (e.g. 2,6 di-tertiary butyl phenoxy).

Boron heterocyclic ligands are characterized by the presence of a boron atom in a closed ring ligand. This definition includes heterocyclic ligands which also contain a nitrogen atom in the ring. These ligands are well known to those skilled in the art of olefin polymerization and are fully described in the literature (see, for example, U.S. Pat. Nos. 5,637,659; 5,554,775; and the references cited therein).

The term “phosphole” is also meant to convey its conventional meaning. “Phospholes” are cyclic dienyl structures having four carbon atoms and one phosphorus atom in the closed ring. The simplest phosphole is C₄PH₄ (which is analogous to cyclopentadiene with one carbon in the ring being replaced by phosphorus). The phosphole ligands may be substituted with, for example, C₁₋₂₀ hydrocarbyl radicals (which may, optionally, contain halogen substituents); phosphido radicals; amido radicals; or silyl or alkoxy radicals. Phosphole ligands are also well known to those skilled in the art of olefin polymerization and are described as such in U.S. Pat. No. 5,434,116 (Sone, to Tosoh).

In one embodiment the catalyst may contain no phosphinimine ligands as the bulky heteroatom ligand. The bulky heteroatom containing ligand may be selected from the group consisting of ketimide ligands, silicon-containing heteroatom ligands, amido ligands, alkoxy ligands, boron heterocyclic ligands and phosphole ligands. In such catalysts the Cp ligand may be present or absent.

The preferred metals (M) are from Group 4 (especially titanium, hafnium or zirconium), with titanium being most preferred.

For gas phase or slurry phase polymerization the catalyst may be supported.

The catalyst system of the present invention may be supported on an inorganic or refractory support, including for example alumina, silica and clays or modified clays or an organic support (including polymeric support such as polystyrene or cross-linked polystyrene). The catalyst support may be a combination of the above components. However, preferably the catalyst is supported on an inorganic support or an organic support (e.g. polymeric) or mixed support. Some refractories include silica, which may be treated to reduce surface hydroxyl groups and alumina. The support or carrier may be a spray-dried silica. Generally the support will have an average particle size from about 0.1 to about 1,000, preferably from about 10 to 150 microns. The support typically will have a surface area of at least about 10 m²/g, preferably from about 150 to 1,500 m²/g. The pore volume of the support should be at least 0.2, preferably from about 0.3 to 5.0 ml/g.

Generally the refractory or inorganic support may be heated at a temperature of at least 200° C. for up to 24 hours, typically at a temperature from 500° C. to 800° C. for about 2 to 20, preferably 4 to 10 hours. The resulting support will be essentially free of adsorbed water (e.g. less than about 1 weight %) and may have a surface hydroxyl content from about 0.1 to 5 mmol/g of support, preferably from 0.5 to 3 mmol/g.

A silica suitable for use in the present invention has a high surface area and is amorphous. For example, commercially available silicas are marketed under the trademark of Sylopol® 958 and 955 by Davison Catalysts, a Division of W.R. Grace, and Company and ES-70W sold by Ineos Silica.

The amount of the hydroxyl groups in silica may be determined according to the method disclosed by J. B. Peri and A. L. Hensley, Jr., in J. Phys. Chem., 72 (8), 2926, 1968, the entire contents of which are incorporated herein by reference.

While heating is the most preferred means of removing OH groups inherently present in many carriers, such as silica, the OH groups may also be removed by other removal means, such as chemical means. For example, a desired proportion of OH groups may be reacted with a suitable chemical agent, such as a hydroxyl reactive aluminum compound (e.g. triethyl aluminum) or a silane compound. This method of treatment has been disclosed in the literature and two relevant examples are: U.S. Pat. No. 4,719,193 to Levine in 1988 and by Noshay A. and Karol F. J. in Transition Metal Catalyzed Polymerizations, Ed. R. Quirk, 396, 1989. For example the support may be treated with an aluminum compound of the formula Al((O)ₐR¹)_{b}X_{3-b} wherein a is either 0 or 1, b is an integer from 0 to 3, R¹ is a C₁₋₈ alkyl radical, and X is a chlorine atom. The amount of aluminum compound is such that the amount of aluminum on the support prior to adding the remaining catalyst components will be from about 0 to 2.5 weight %, preferably from 0 to 2.0 weight % based on the weight of the support.

The clay type supports are also preferably treated to reduce adsorbed water and surface hydroxyl groups. However, the clays may be further subject to an ion exchange process, which may tend to increase the separation or distance between the adjacent layers of the clay structure.

The polymeric support may be cross linked polystyrene containing up to about 50 weight %, preferably not more than 25 weight %, most preferably less than 10 weight % of a cross linking agent such as divinyl benzene.

The catalysts in accordance with the present invention may be activated with an activator selected from the group consisting of:

(i) a complex aluminum compound of the formula R¹²₂AlO(R¹²AlO)ₘAlR¹²₂ wherein each R¹² is independently selected from the group consisting of C₁₋₂₀ hydrocarbyl radicals and m is from 3 to 50, and optionally a hindered phenol to provide a molar ratio of Al:hindered phenol from 2:1 to 5:1 if the hindered phenol is present;

(ii) ionic activators selected from the group consisting of:
(A) compounds of the formula [R¹³]⁺[B(R¹⁴)₄r]⁻ wherein B is a boron atom, R¹³ is a cyclic C₅₋₇ aromatic cation or a triphenyl methyl cation and each R¹⁴ is independently selected from the group consisting of phenyl radicals which are unsubstituted or substituted with a hydroxyl group or with 3 to 5 substituents selected from the group consisting of a fluorine atom, a C₁₋₄ alkyl or alkoxy radical which is unsubstituted or substituted by a fluorine atom and a silyl radical of the formula —Si—(R¹⁵)₃ wherein each R¹⁵ is independently selected from the group consisting of a hydrogen atom and a C₁₋₄ alkyl radical; and
(B) compounds of the formula [(R¹⁸)ₜ ZH]⁺[B(R¹⁴)₄]⁻ wherein B is a boron atom, H is a hydrogen atom, Z is a nitrogen atom or phosphorus atom, t is 2 or 3 and R¹⁸ is independently selected from the group consisting of C₁₋₁₈ alkyl radicals, a phenyl radical which is unsubstituted or substituted by up to three C₁₋₄ alkyl radicals, or one R¹⁸ taken together with the nitrogen atom may form an anilinium radical and R¹⁴ is as defined above; and
(C) compounds of the formula B(R¹⁴)₃ wherein R¹⁴ is as defined above; and

(iii) mixtures of (i) and (ii).

Preferably the activator is a complex aluminum compound of the formula R¹²₂AlO(R¹²AlO)ₘAlR¹²₂ wherein each R¹² is independently selected from the group consisting of C₁₋₂₀ hydrocarbyl radicals and m is from 3 to 50, and optionally a hindered phenol to provide a molar ratio of Al:hindered phenol from 2:1 to 5:1 if the hindered phenol is present. In the aluminum compound preferably, R¹² is methyl radical and m is from 10 to 40. The preferred molar ratio of Al:hindered phenol, if it is present, is from 3.25:1 to 4.50:1. Preferably the phenol is substituted in the 2, 4 and 6 position by a C₂₋₆ alkyl radical. Desirably the hindered phenol is 2,6-di-tert-butyl-4-ethyl-phenol.

The aluminum compounds (alumoxanes and optionally hindered phenol) are typically used as activators in substantial molar excess compared to the amount of metal in the catalyst. Aluminum:transition metal molar ratios of from 10:1 to 10,000:1 are preferred, most preferably 10:1 to 500:1 especially from 40:1 to 120:1.

Ionic activators are well known to those skilled in the art. The “ionic activator” may abstract one activatable ligand so as to ionize the catalyst center into a cation, but not to covalently bond with the catalyst and to provide sufficient distance between the catalyst and the ionizing activator to permit a polymerizable olefin to enter the resulting active site.

Examples of ionic activators include:
triethylammonium tetra(phenyl)boron,
tripropylammonium tetra(phenyl)boron,
tri(n-butyl)ammonium tetra(phenyl)boron,
trimethylammonium tetra(p-tolyl)boron,
trimethylammonium tetra(o-tolyl)boron,
tributylammonium tetra(pentafluorophenyl)boron,
tripropylammonium tetra(o,p-dimethylphenyl)boron,
tributylammonium tetra(m,m-dimethylphenyl)boron,
tributylammonium tetra(p-trifluoromethylphenyl)boron,
tributylammonium tetra(pentafluorophenyl)boron,
tri(n-butyl)ammonium tetra(o-tolyl)boron,
N,N-dimethylanilinium tetra(phenyl)boron,
N,N-diethylanilinium tetra(phenyl)boron,
N,N-diethylanilinium tetra(phenyl)n-butylboron,
di-(isopropyl)ammonium tetra(pentafluorophenyl)boron,
dicyclohexylammonium tetra(phenyl)boron,
triphenylphosphonium tetra(phenyl)boron,
tri(methylphenyl)phosphonium tetra(phenyl)boron,
tri(dimethylphenyl)phosphonium tetra(phenyl)boron,
tropillium tetrakispentafluorophenyl borate,
triphenylmethylium tetrakispentafluorophenyl borate,
tropillium phenyltrispentafluorophenyl borate,
triphenylmethylium phenyltrispentafluorophenyl borate,
benzene(diazonium)phenyltrispentafluorophenyl borate,
tropillium tetrakis (2,3,5,6-tetrafluorophenyl)borate,
triphenylmethylium tetrakis(2,3,5,6-tetrafluorophenyl)borate,
tropillium tetrakis(3,4,5-trifluorophenyl)borate,
benzene(diazonium)tetrakis(3,4,5-trifluorophenyl)borate,
tropillium tetrakis(1,2,2-trifluoroethenyl)borate,
triphenylmethylium tetrakis(1,2,2-trifluoroethenyl)borate,
tropillium tetrakis(2,3,4,5-tetrafluorophenyl)borate, and
triphenylmethylium tetrakis(2,3,4,5-tetrafluorophenyl)borate.

Readily commercially available ionic activators include:
N,N-dimethylaniliniumtetrakispentafluorophenyl borate;
triphenylmethylium tetrakispentafluorophenyl borate(tritylborate); and
trispentafluorophenyl borane.

Ionic activators may also have an anion containing at least one group comprising an active hydrogen or at least one of any substituent able to react with the support. As a result of these reactive substituents, the ionic portion of these ionic activators may become bonded to the support under suitable conditions. One non-limiting example includes ionic activators with tris (pentafluorophenyl) (4-hydroxyphenyl) borate as the anion. These tethered ionic activators are more fully described in U.S. Pat. Nos. 5,834,393, 5,783,512 and 6,087,293.

In accordance with the present invention, the polyethylene may be prepared by solution, slurry or gas phase processes.

Solution and slurry polymerization processes are fairly well known in the art. These processes are conducted in the presence of an inert hydrocarbon solvent typically a C₄₋₁₂ hydrocarbon which may be unsubstituted or substituted by a C₁₋₄ alkyl group such as butane, pentane, hexane, heptane, octane, cyclohexane, methylcyclohexane or hydrogenated naphtha. An additional solvent is Isopar E (C₈₋₁₂ aliphatic solvent, Exxon Chemical Co.).

The polymerization may be conducted at temperatures from about 20° C. to about 250° C. Depending on the product being made, this temperature may be relatively low such as from 20° C. to about 180° C., typically from about 80° C. to 150° C. and the polymer is insoluble in the liquid hydrocarbon phase (diluent) (e.g. a slurry polymerization). The reaction temperature may be relatively higher from about 180° C. to 250° C., preferably from about 180° C. to 230° C. and the polymer is soluble in the liquid hydrocarbon phase (solvent). The pressure of the reaction may be as high as about 15,000 psig for the older high pressure processes or may range from about 15 to 4,500 psig.

In the gas phase polymerization a gaseous mixture comprising from 0 to 15 mole % of hydrogen, monomers as noted above, and from 0 to 75 mole % of an inert gas at a temperature from 50° C. to 120° C., preferably from 75° C. to about 110° C., and at pressures typically not exceeding 3447 kPa (about 500 psi), preferably not greater than 2414 kPa (about 350 psi) is contacted with a supported catalyst as noted above and polymerized.

It has been well recognized that a semi-crystalline polyethylene resin consists of at least three phases, i.e., crystalline, amorphous and interfacial phases. The amount of interfacial phase actually contains the contribution of tie chains which has long been known as one of the key fundamental resin parameters in determining many polyethylene product properties such as toughness, environmental stress cracking resistance, etc. The amount of interfacial phase can be used as an indication of the amount of tie chains. Hence, within the same resin category (e.g., HDPE or MDPE), a resin with the higher amount of interfacial phase would typically be expected to provide a higher toughness than another with a lower amount of interfacial phase, either alone or in a system such as composites. The single sited catalyzed polyethylenes of the present invention have a higher amount of polymer in the interfacial phase between the crystalline phase and the amorphous phase and as such have a higher degree of tie chains between these phases in the polymer. The increase in the amount of interfacial phase in the single site catalyzed (SSC) polyethylenes over those of comparable, conventional Ziegler-Natta catalyzed polyethylenes (e.g. comparable polyethylenes having a composition within 5 weight %, preferably within 2 weight % of the single site catalyzed polyethylene, density within 0.005 g/cm³ of the single site catalyzed polyethylene, and a melt index within 0.5 g/10 min, preferably 0.2 g/10 min. of the single site catalyzed polyethylene) may range from about 1.5 to 7 weight %, preferably from about 2 to 6 weight % as inferred using Raman spectroscopy (using a 514.5 nm laser Raman Spectroscopy).

The polyethylene may be present in the compositions of the present invention in an amount from 79 to 50, preferably from 52 to 72 weight %.

The second component in the compositions of the present invention is the polar polymer that acts as a compatabilizing agent or adhesion promoter to increase the bonding strength between the glass fiber and the polymer matrix. The polar polymer may be present in the compositions of the present invention in amounts from 1 to 10 weight %, preferably from 2 to 8 weight %. The polar polymer may be selected from (but not limited to) the following groups:

(i) Olefinic homopolymers and copolymers (e.g. polymers comprising from 90 to 100 weight % of ethylene and from 0 to 10 weight % of one or more C₃₋₁₀, preferably C₄₋₈ olefins, preferably alpha olefins) that have been modified through grafting with up to 10 weight %, preferably from 2 to 8 weight %, typically from 4 to 8 weight % of one or more C₃₋₆ ethylenically unsaturated carboxylic acids, anhydrides and imides. Examples include, but are not limited to, so-called compatibilizers such as BYNEL® products (from DuPont Company) maleic anhydride modified polyolefins available under the POLYBOND® (Chemtura) product range.

(ii) Copolymers comprising from about 99 to 50 weight %, preferably from 99 to 80, typically from 95 to 80 of one or more C₂₋₈ olefin monomers (e.g. ethylene) and which incorporate from 1 to 50 weight %, preferably from 1 to 20 weight %, typically from 5 to 20 weight % of one or more C₃₋₈ ethylenically unsaturated polar monomers including but not limited to carboxylic acids, anhydrides, imides, glycidyl methacrylate and carboxylic acid derivatives, including vinyl acetate esters (ethylene vinyl acetate) and ionomers (alkali or alkali earth metal salts of acidic polymers e.g. ethylene acrylate salts).

In one embodiment the polar polymer is selected from the group consisting of glycidyl methacrylate, ionomers of 80 to 95 weight % of ethylene and 20 to 5 weight % of one or more C₃₋₆ carboxylic acids; copolymers of 80 to 95 weight % of ethylene and 20 to 5 weight % of one or more C₃₋₆carboxylic acids, copolymers of 80 to 95 weight % of ethylene and 20 to 5 weight % of one or more anhydrides of C₃₋₆carboxylic acids and copolymers of 80 to 95 weight % of ethylene and 20 to 5 weight % of one or more imides of C₃₋₆carboxylic acids and ethylene vinyl acetate.

The fibers useful in the present invention may be selected from the group consisting of consisting of glass fibers, carbon fibers, graphite fibers, and polyaramid fibers. The glass fibers could be E glass or S glass fibers. The carbon fibers could be produced by a number of methods such as drawing and thermal decomposition of polyacrylonitrile (PAN) or pitch. The fibers could be graphite fibers. The fibers could be synthetic organic fibers such as, without limitation, polyaramid fibers. In some cases (e.g. glass) the fibers are typically sized before use to protect the fibers. Typically the fibers are bundled in a roving for use (e.g. with ten or more fibers to a roving).

The fibers may be present in the composites of the present invention in an amount from 20 to 40, preferably from 25 to 40 weight % of the composite. The fibers have a nominal length of at least 1.25 cm (½ inch) typically from about 2 cm to 25 cm. The fibers may have a diameter from about 10 to 20 μm, preferably from 10 to 15 μm, most preferably from 10 to 13 μm. In the composite the fibers will have a low degree, less than 25%, preferably less than 15%, most preferably less than 10% of orientation in the same direction. As a result the physical properties of the composite when measured in different directions (e.g. the x, y, and z planes) are not the same. They may be with in X % of each other where X is the per cent of fiber orientation in the same direction.

The composite may be in the form of sheet material having a front or face, a back and an edge or perimeter. One particularly useful form of sheet material is in the form of a monolithic slab or sheet having a thickness of not less than ½ an inch (1.25 cm). There is no limit on the thickness, it may be up to about 5 inches (10.7 cm), typically to 2 inches (5.08 cm) thick, preferably from ½ inch to 1 inch (2.54 cm) thick. The sheet may have a length from 1.82 meters (6 feet) to 3.02 meters (10 feet), preferably 2.44 meters (8 feet) and a width from 0.60 meters (2 feet) to 1.83 meters (6 feet), preferably 1.22 meters (4 feet).

The sheet should be flat on at least one face. The sheet may have a lip or half lip on said one face extending in at least a half inch (1.3 cm) from the perimeter of the sheet, in which case the surfaces of the sheets could be fitted together so the lips on adjacent sheets overlap. In some instances it may be desirable to have a reinforcing structure on the backside or back surface of the sheet to further increase stiffness and decrease the total part weight. This reinforcing structure could be in the form of straight ribs having a flat or sloping or rounded upper edge. The ribs could be cross ribs (forming a cross, diamond or argyle pattern) on the back of the sheet. The reinforcement could be in the form of a raised honeycomb structure on the back of the sheet. In one embodiment, the sheet could have regularly spaced channels having a depth not more than a quarter of the thickness of the sheet, which channels are adapted to cooperate with and receive reinforcing rods or bars.

In a further embodiment the composite may be in the form of a “sandwich” construction. In one form the face and back of the sheet are monolithic structures and the middle is a reinforcing structure such as a sheet or web of a honeycomb material or some other reinforcing structure. In an alternate embodiment the “sandwich” merely comprises a front and back face each having on their back surface interspaced and preferably cooperating reinforcing structures such as ribs or diamond structures. In a further embodiment one or more of the front or back monoliths could be replaces with sheet metal such as steel or over coated with sheet metal.

In one embodiment of the invention the sheets are used to make forms for pouring concrete. The sheets exhibit good impact and tensile properties, have a low degree of warpage and if required, can be cut using conventional equipment available at construction sites. Additionally, the sheets of the present invention release relatively easily from the set concrete without the use or significant use of an externally applied release aid.

The sheet materials of the present invention may be prepared by a number of methods. The sheet could be prepared by compression molding. Generally, a pre-impregnated composite of long or chopped glass fiber randomly oriented is prepared in a sheet form and put into a suitable mold and the polyolefin composite (e.g. polyethylene composition) is then injected into the mold. When the mold cools a solid sheet is formed. Another compression process uses a low shear screw in an injection machine to deliver the polymer fiber, preferably glass, composition into half of a compression mold and the other half of the mold is applied in a separate step. Preferably the injection machine is fitted with a low shear screw or screw having a distance between adjacent flights on the screw greater than the desired length of the fiber used to reinforce the composite. This tends to reduce fiber length attrition. Preferably the forming process (extrusion, etc.) is such that fiber length attrition (loss of initial fiber length in the feed to the molding machine measured by comparing the fiber length in the molded part versus the fiber length fed to the extruder) is less than 30%, preferably less than 20%, most preferably less than 15%.

In one embodiment the composite of the present invention is passed through the injection molding machine into a mold or half mold and formed into a large sheet, comparable in size to a 122×243×13 cm (48×96×½ inch) sheet of plywood. Once the mold cools, the solid sheet of composite material is removed. In use, the sheet can be used to replace plywood in a number of applications such as forms to pour concrete. In further embodiments the composite is formed in a mold into a sheet and may be sandwiched (heat sealed together or some other means) with one or more other sheets or reinforcing sheets or webs to form a sandwich structure.

The present invention will now be illustrated by the following non-limiting examples.

In the comparative examples the polyethylene resin was a solution polyethylene resin RMs539-U made in the presence of a single site catalyst.

In the examples the single site type resin was a solution polyethylene resin made in the presence of a indenyl, tri-tertary butyl phosphimine titanium di methyl compound activated with trityl borate.

### EXAMPLE 1

Interfacial phase between the crystalline and amorphous phases of the polymer

A high density and a medium density polyethylene (ethylene-octane copolymer) prepared using a cyclopentadienyl, tri-tert. butyl phosphinimine titanium di chloride as a catalyst and trytil borate as a cocatalyst were compared with commercially available Ziegler-Natta catalyzed polyethylene (ethylene-hexene) for amount of interfacial component between the surface of the crystalline phase and the amorphous phase (i.e. where there is no longer any crystallinity).

The plaque for Raman measurement in this disclosure was prepared by compression molding as follows. The mold (and with two bottom/upper plates to shape the plaque) was heated from room temperature to 175° C. At this temperature, the resin pellets were then put into the mold and a lower compression pressure of about 42 psi was applied to the plates for 5 minutes. After that, a higher compression pressure of about 430 psi was applied for another 5 minutes at 175° C. The temperature of the mold was cooled at a rate of 15° C./min to 70° C., and then to 40° C. at a rate of about 10° C./min. The plaque was removed from the mold and conditioned at room temperature for at least 24 hours for any other tests. Raman spectra were collected from the samples using a 514.5 nm laser Raman Spectroscopy. Various portions of the Raman spectra were integrated to calculate the fraction of CH₂ units in the crystalline phase (a_{c}) and in the amorphousphase (aₐ).

The CH₂ twisting band at 1298 cm⁻¹ (not related to any particular conformation of the molecular chains) was integrated over the range from 1352 cm⁻¹ to 1253 cm⁻¹ using Grams AI (Version 7.00). This gives the value for an internal reference I_{ref}. The intensity for the crystalline portion of the polymer was determined by curve fitting three peaks centered at 1461, 1442, and 1416 cm⁻¹ in the region between 1550 to 1400 cm⁻¹ using a 100% Gaussian distribution which was iterated until convergence. This gave the intensity I₁₄₁₆. The amount of the crystalline (crystalline orthorhombic) phase is then calculated using the equation:

a_{c}=I₁₄₁₆/(0.46 I_{ref})

The constant 0.46 is determined from the spectrum of fully crystalline polyethylene using 514.5 nm laser Raman spectroscopy (see the method of R. P. Paradkar, S. S. Sakhalkar, X. He and M. S. Ellison, J. AppI. Polym. Sci., 88, 545 (2003)).

The CH₂ twisting peaks at 1303 and 1298 cm⁻¹ were fitted to the 1303 cm⁻¹ position using a mixed 60% Gausian and 40% Lorentzian curve fitting program to give the intensity at 1303 cm⁻¹ (I₁₃₀₃) the amorphous portion of the polymer was then calculated using the formula:

Aₐ=I₁₃₀₃/I_{ref}

The constant 1 in the denominator was measured from the spectrum of fully amorphous polyethylene using a 514.5 nm laser Raman spectroscopy (see the method of R. P. Paradkar, S. S. Sakhalkar, X. He and M. S. Ellison, J. Appl. Polym. Sci., 88, 545 (2003)).

Finally, the amount of polymer in the interfacial phase (connecting the crystalline phase and the amorphous phase) is then given by:

a_{b}=1−a_{c}−aₐ

The results are shown in Table 1.

TABLE 1

| | | | | | Amount of | Amount of | Amount of | 1% Flexural | |
|---|---|---|---|---|---|---|---|---|---|
| Resin | Resin | Density | MI | Catalyst | crystalline | amorphous | interfacial | Modulus | Tensile Yield |
| matrix | category | (g/cc) | (g/10 min.) | system | phase (%) | phase (%) | phase (%) | (MPa) | Stress (MPa) |
| SSC-A | HDPE | 0.944 | 1.7 | SSC | 71.59 | 13.64 | 14.77 | 990 | 23.5 |
| ZN-B | HDPE | 0.942 | 1.8 | ZN | 68.4 | 18.74 | 12.86 | 920 | 21.1 |
| SSC-C | MDPE | 0.939 | 5.2 | SSC | 62.84 | 19.68 | 17.48 | 750 | 19.9 |
| ZN-D | MDPE | 0.935 | 5 | ZN | 63.41 | 24.69 | 11.9 | 620 | 17.4 |

The results of Table 1 show that polyethylene resins produced using single site resins have a higher content of polymer chains (tie chains) connecting the crystalline region and the amorphous region than comparable polymers produced using Ziegler-Natta catalysts, and thus should provide at least better toughness than the latter in a system such as composites.

### EXAMPLE 2

The following materials were used in this comparative example:

SURPASS® RMs539—a commercial SURPASS® polyethylene (Melt Index=5.5 g/10 min, Density=0.939 g/cm³. Abbreviated as RMs539 below).

PS-65146—a dual reactor SSC pilot plant polyethylene with similar architecture as RMs539, but with lower viscosity (Melt Index=15 g/10 min, Density=0.939 g/cm3).

JM741—Johns Manville ½″ (1.25 cm) E-type long glass fiber roving sized (treated) for polyolefin incorporation.

JM735—alternate Johns Manville ½″ (1.25 cm) E-type long glass fiber roving sized for polyolefin incorporation.

Formulations trialed in Example 1 included:
100% RMs539
100% PS-65146
30% JM741/70% RMs539 (by weight)
30% JM735/70% RMs539 (by weight)
30% JM741/70% PS-65146 (by weight)
30% JM735/70% PS-65146 (by weight)

The formulations were initially weighed out and dry blended prior to melt compounding. The compounding/melt deposition/forming work was performed on a low shear thermo plastic forming line as described in the Polk patents noted above. The compounding step was accomplished using a 6 inch single screw extrusion system fitted with a proprietary low shear screw (to limit fiber attrition). The molten composition was delivered directly to the bottom half of the forming mold via a coat hanger style die system equipped with programmable die lips. This feature allowed for shaped delivery of the molten composition as the forming mold was transported under the die. The molten material was then quickly shuttled into the compression chamber where the upper half of the mold was applied to shape the sheet. Several minutes later, the solidified composite sheet was removed from the mold and the process was repeated.

Samples were molded as monolithic 24″×24″ sheets at two different thicknesses: ⅛″ and ½″. The ⅛″ thick samples were used for relative physical strength and stiffness evaluations. The ½″ samples are more representative of the desired final product. The results are shown in table 2

TABLE 2

| | | 70% PS-65146 | 70% PS-65146 | | | |
|---|---|---|---|---|---|---|
| | 100% | 30% | 30% | 100% | 70% RMs539-U | 70% RMs539-U |
| | PS-65146 | JM741 GF | JM735 GF | RMs539-U | 30% JM741 GF | 30% JM735 GF |
| PHYSICAL FORM | ⅛″ | ⅛″ PLAQUE | ⅛″ PLAQUE | ⅛″ | ⅛″ PLAQUE | ⅛″ PLAQUE |
| | PLAQUE | | | PLAQUE | | |

FLEX MODULUS - Crosshead speed at 5 mm/min or 0.2 Inch/min, 5″ × 1.5″

| | | | | | | | |
|---|---|---|---|---|---|---|---|
| FLEXURAL 1% SECANT MODULUS | MPA | 637 | 1385 | 1402 | 593 | 2761 | 2733 |
| FLEXURAL 2% SECANT MODULUS | MPA | 543 | 1213 | 1196 | 507 | 2209 | 2224 |
| FLEXURAL STRENGTH | MPA | 22.3 | 43.4 | 38.7 | 22.5 | 53.4 | 54.2 |
| FLEXURAL TAN MODULUS | MPA | 766 | 1459 | 1574 | 680 | 3159 | 3073 |

IMPACT

| | | | | | | | |
|---|---|---|---|---|---|---|---|
| NOTCHED IZOD | FTLB/IN | 1.9 | 2.4 | 1.6 | 4.3 | 1.9 | 1.6 |

TENSILES - Crosshead speed at 5 mm/min or 0.2 inch/min, 5″ × 1.5″

| | | | | | | | |
|---|---|---|---|---|---|---|---|
| ELONGATION | % | 0 | 8.3 | 6.2 | 0 | 4.7 | 6.2 |
| STRENGTH | MPA | 0 | 35.9 | 29.9 | 0 | 29.5 | 27.9 |
| ELONGATION AT YIELD | % | 25.9 | 8.3 | 6.2 | 27 | 4.7 | 6.2 |
| STRENGTH AT YIELD | MPA | 14.5 | 35.9 | 29.9 | 13.6 | 29.5 | 27.9 |

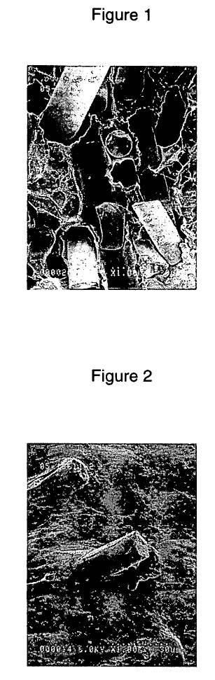

The composite materials from Example 2 demonstrate lower stiffness opposite commercial PP and HDPE reinforced with LGF, e.g. lower flexural modulus, lower flexural strength and lower tensile strength. Performance differences observed for long glass fiber (LGF) reinforced RMs539 and PS65146 were predominantly due to the variance in melt index of the PE matrix. The observed deficiencies of the RMs539-U LGF reinforced composition were attributed to poor adhesion of the glass fibers to PE matrix. This was confirmed with SEM analysis of the fracture surfaces, which showed poorly wetted glass surfaces and extensive fiber pullout. FIG. 1 is an SEM photomicrograph of a composite of a single site resin (RMs539) as the matrix and 30 weight % of glass without any polar polymer.

### EXAMPLE 3

The following materials were used in this comparative example:

SURPASS® RMs539—a commercial SURPASS® polyethylene (Melt Index=5.5 g/10 min, Density=0.939 g/cm³. Abbreviated as RMs539 below).

PS-65146—a dual reactor SSC pilot plant polyethylene with similar architecture as RMs539, but with lower viscosity (Melt Index=15 g/10 min, Density=0.939 g/cm3).

JM741—Johns Manville ½″ (1.25 cm) E-type long glass fiber roving sized (treated) for polyolefin incorporation.

JM735—alternate Johns Manville ½″ (1.25 cm) E-type long glass fiber roving sized for polyolefin incorporation.

FUSABOND E MB528D maleic anhydride modified LLDPE resin from DuPont Packaging and Industrial Polymers (Melt Index=6.8 g/10 min, Density=0.92 g/cm3 MAH=1.1%).

Formulations trialed in Example 3 included:
30% JM741/65% PS66345/5% Fusabond (by weight).
30% JM735/68% PS66345/2% Fusabond (by weight).
30% JM735/65% RMs539/5% Fusabond (by weight).

All composite samples were prepared in the same manner as Example 1. Test results for ½″ thick samples are tabulated below.

| | | | | 65% PS66345 + | | 68% PS66345 + | | 65% RNs539 + | |
|---|---|---|---|---|---|---|---|---|---|
| | | 100% | 100% | 30% JM741 + | | 30% JM741 + | | 30% JM735 + | |
| SAMPLE | Units | PS65146 | RMs539-U | 5% Fusabond | | 2% Fusabond | | 5% Fusabond | |
| LIMS Request | | P05-2859 | P05-2859 | P05-3415/3354 | P05-3885 | P05- | P05-3885 | P05- | P05-3885 |
| | | | | | | 3415/3354 | | 3415/3354 | |
| PHYS_FORM | | ⅛″ | ⅛″ | ⅛″ | ⅛″ | ⅛″ | ⅛″ | ⅛″ | ⅛″ |
| | | PLAQUE | PLAQUE | PLAQUE | PLAQUE | PLAQUE | PLAQUE | PLAQUE | PLAQUE |

FLEX MODULUS - Crosshead speed at 5 mm/min or 0.2 Inch/min

| | | | | | | | | | |
|---|---|---|---|---|---|---|---|---|---|
| Test Bar Dimensions ( [symbol] w) | | 5″ × 0.5″ | 5″ × 0.5″ | 5″ × 0.5″ | 5″ × 1.0″ | 5″ × 0.5″ | 5″ × 1.0″ | 5″ × 0.5″ | 5″ × 1.0″ |
| Flexural Secant Modulus@1% MD | MPA | 637 | 593 | 2676 | 2267 | 2739 | 2464 | 2110 | 3165 |
| Flexural Secant Modulus@2% MD | MPA | 543 | 507 | 2296 | 1947 | 2364 | 2076 | 1795 | 2757 |
| Flexural Strength MD | MPA | 22.3 | 22.5 | 84.7 | 74 | 87 | 72 | 67.1 | 96 |
| Flexural Tangent Modulus MD | MPA | 766 | 680 | 2949 | 2384 | 2728 | 2547 | 2219 | 2503 |
| Flexural Tangent Modulus TD | MPA | | | 1274 | 1398 | 1711 | 1346 | 1228 | 1732 |

IZOD IMPACT

| | | | | | | |
|---|---|---|---|---|---|---|
| Izod Impact MD, Hotched | FTLB/01 | 1.9 | 4.3 | 4.4 | 5.1 | 4 |

PLQ TENSILES - Crosshead speed at 5 mm/min or 0.2 inch/min

| | | | | | | | | | |
|---|---|---|---|---|---|---|---|---|---|
| Test Bar Dimensions ( [symbol] w) | | 5″ × 0.5″ | 5″ × 0.5″ | 5″ × 0.5″ | 5″ × 1.0″ | 5″ × 0.5″ | 5″ × 1.0″ | 5″ × 0.5″ | 5″ × 1.0″ |
| Elongation at Break MD | % | | | 13 | 13 | 14 | 16 | 17 | 21 |
| Tensile Strength@Break MD | MPA | | | 36.5 | 43 | 44.8 | 50 | 32.6 | 35 |
| Elongation at Yield MD | % | 25.9 | 27 | 12 | 11 | 13 | 14 | 15 | 16 |
| Yield Strength MD | MPA | 14.5 | 13.6 | 36.7 | 45 | 45.3 | 50 | 32.8 | 36 |

DYNATUP (23° C.)

| | | | | |
|---|---|---|---|---|
| DYNATUP ENGY | FTLB | 24.7 | 14.6 | 23.8 |
| DYNATUP ENGY-DV | FTLB | 1.8 | 4.2 | 4.1 |
| DYNATUP MAX | LB | 650 | 401 | 554 |
| DYNATUP MAX-DV | LB | 96 | 53 | 83 |

DYNTUP (−20° C.)

| | | | | |
|---|---|---|---|---|
| DYNATUP ENGY | FTLB | 32.6 | 17.9 | 24.2 |
| DYNATUP ENGY-DV | FTLB | 5.6 | 2.2 | 5.3 |
| DYNATUP MAX | LB | 711 | 465 | 618 |
| DYNATUP MAX-DV | LB | 87 | 46 | 95 |

OTHER

| | | | | | | | |
|---|---|---|---|---|---|---|---|
| ASH PCT (single run) | % | 28.9295 | | 29.2106 | | 27.8673 | |
| ASH PCT (Avg of [symbol] runs) | % | 29.6102 | | 29.9414 | | 28.9356 | |
| ASH Std Dev | | 1.29 | | 1.27 | | 1.42 | |
| Ash Homogeniety | % of Avg | 4.34 | | 4.25 | | 4.91 | |
| HDT @ 264 p [symbol] l | ° C. | | 65 | | 77 | | 69 |
| HDT @ 66 p [symbol] l | ° C. | | 120 | | 118 | | 117 |
| VICAT Softening Point | ° C | | 128 | | 124 | | 128 |
| Shore Hardness - D | | | 73 | | 69.3 | | 71.1 |

[symbol]

indicates data missing or illegible when filed

It was observed that the glass fibers wetability in SURPASS® PE has been substantially improved through addition of maleic anhydride (Fusabond).

Product performance of GFR SURPASS® materials is comparable to commercial HDPE.

The following composite properties were substantially improved by including 2-5% Fusabond maleic anhydride grafted polyethylene as an adhesion promoter (compatibilizer) in the SURPASS® RMs539-based LGF formulations:

Flexural Strength (increased approximately 60%).

Notched IZOD Impact Strength (increased approximately 140%).

Elongation at Break (increased approximately 100%).

Tensile Strength at Break (increased approximately 35%).

Elongation at Yield (increased approximately 100%).

Tensile Strength at Yield (increased approximately 160%).

Adhesion between the polymer matrix and the glass fiber surface was greatly increased, as indicated by the Scanning Electron Micrographs of the composite fracture surfaces. Note that fiber pullout is greatly reduced and glass surfaces show clear signs of polymer bonding. FIG. 2 is a SEM photomicrograph of a composite made with a single site resin (RMs539) as the matrix and 30 weight % of glass with 5% of a polar polymer (a polyethylene maleic anhydride graft copolymer).

What is claimed is:

1. A polyolefin composition which when formed into a sheet material has a flexural modulus strength in the extrusion flow direction of not less than 650 MPA, as determined by ASTM D 790; an elongation at yield in the extrusion flow direction of not more than 16% as measured by ASTM D 638; a tensile strength at break in the extrusion flow direction of not less than 30 MPA as measured by ASTM D 638; a yield strength (extrusion flow direction) of not less than 30 MPA as determined by ASTM D 638 comprising:
(i) from 20 to 40 weight % of reinforcing fibers having a nominal length of at least 1.25 cm;
(ii) from 1 to 10 weight % of a polar polymer; and
(iii) from 79 to 50 weight % of a polyethylene having a density greater than 0.935 g/cc and an MI from 0.5 to 10 g/10 min, prepared by polymerizing from 95 to 99.9 weight % of one or more C₂₋₄ alpha olefin monomers and from 0.01 to 5 weight % of one or more C₆₋₈ alpha olefin monomers in the presence of a catalyst selected from the group consisting of:
(L)ₙ-M-(Y)ₚ
wherein M is selected from the group consisting of Ti, Zr, and Hf; L is a monoanionic ligand independently selected from the group consisting of cyclopentadienyl-type ligands, and a bulky heteroatom ligand containing not less than five atoms in total of which at least 20%, numerically are carbon atoms and further containing at least one heteroatom selected from the group consisting of boron, nitrogen, oxygen, phosphorus, sulfur and silicon said bulky heteroatom ligand being sigma or pi-bonded to M; Y is independently selected for the group consisting of activatable ligands; n may be from 1 to 3; and p may be from 1 to 3, provided that the sum of n+p equals the valence state of M, and further provided that two L ligands may be bridged, and an activator.

2. The polyolefin composition according to claim 1, wherein the reinforcing fibers have a nominal length from 2 to 25 cm.

3. The polyolefin composition according to claim 2, wherein the polar polymer is selected from the group consisting of:
(i) olefinic homopolymers and copolymers comprising from 90 to 100 weight % of ethylene and from 0 to 10 weight % of one or more C₃₋₁₀, that have been graft modified with up to 10 weight %, of one or more C₃₋₆ ethylenically unsaturated carboxylic acids, anhydrides and imides; and
(ii) copolymers comprising from 99 to 50 weight %, of one or more C₂₋₈ olefin monomers and which incorporate from 1 to 50 weight % of one or more C₃₋₈ ethylenically unsaturated polar monomers.

4. The polyolefin composition, according to claim 3, wherein the polyethylene has a density from 0.939 to 0.959 g/cc and an MI from 2 to 8 g/10 min.

5. The polyolefin composition according to claim 4, wherein the reinforcing fiber is present in an amount from 25 to 40 weight %.

6. The polyolefin composition according to claim 5, wherein the polar polymer is present in an amount from 2 to 8 weight %.

7. The polyolefin composition according to claim 6, wherein the polyethylene is present in an amount from 52 to 72 weight %.

8. The polyolefin composite according to claim 7, wherein the reinforcing fiber is selected from the group consisting of glass fibers, carbon fibers, and polyaramid fibers.

9. The polyolefin composite according to claim 8, wherein the reinforcing fiber is glass.

10. The polyolefin composition, according to claim 9, wherein the polar polymer is selected from the group consisting of glycidyl methacrylate, ionomers of 80 to 95 weight % of ethylene and 20 to 5 weight % of one or more C₃₋₆ carboxylic acids, copolymers of 80 to 95 weight % of ethylene and 20 to 5 weight % of one or more C₃₋₆carboxylic acids, copolymers of 80 to 95 weight % of ethylene and 20 to 5 weight % of one or more anhydrides of C₃₋₆carboxylic acids and copolymers of 80 to 95 weight % of ethylene and 20 to 5 weight % of one or more imides of C₃₋₆carboxylic acids and ethylene vinyl acetate.

11. The polyolefin composition according to claim 9, wherein in the polyolefin the amount of interfacial phase between the crystalline phase and the amorphous phase is from about 1.5 to 7 weight % greater than that in a comparable polyolefin prepared using a Zeigler-Natta catalyst as measured using Raman spectroscopy.

12. The polyolefin composition according to claim 8, in the form of a slab or sheet having a thickness of not less than ½ an inch (1.25 cm).

13. The polyolefin composition according to claim 12, having a length from 1.82 meters (6 feet) to 3.02 meters (10 feet) and a width from 0.60 meters (2 feet) to 1.82 meters (6 feet).

14. The polyolefin composition according to claim 13, having at least one flat face.

15. The polyolefin composition according to claim 14, having a lip or half lip on said one face extending in at least a half inch (⅕ cm) from the perimeter of the sheet.

16. The polyolefin composition according to claim 15, having one or more ribs, honeycomb sections or reinforcing elements on the surface opposite said flat surface.

17. The polyolefin composition according to claim 15, comprising a front and back sheet and intermediate said front and back sheet one or more ribs, honeycomb sections or reinforcing elements.

18. The polyolefin composition according to claim 14, having on the surface opposite said one flat surface channels having a depth not more than ¼ of the thickness of said composition.

19. The polyolefin composition according to claim 4, wherein in said catalyst the cyclopentadienyl-type ligand is a C₅₋₁₃ ligand containing a 5-membered carbon ring having delocalized bonding within the ring and bound to the metal atom through η⁵ bonds and said ligand being unsubstituted or up to fully substituted with one or more substituents selected from the group consisting of C₁₋₁₀ hydrocarbyl radicals in which hydrocarbyl substituents are unsubstituted or further substituted by one or more substituents selected from the group consisting of a halogen atom and a C₁₋₈ alkyl radical; a halogen atom; a C₁₋₈ alkoxy radical; a C₆₋₁₀ aryl or aryloxy radical; an amido radical which is unsubstituted or substituted by up to two C₁₋₈ alkyl radicals; a phosphido radical which is unsubstituted or substituted by up to two C₁₋₈ alkyl radicals; silyl radicals of the formula —Si—(R)₃ wherein each R is independently selected from the group consisting of hydrogen, a C₁₋₈ alkyl or alkoxy radical, and C₆₋₁₀ aryl or aryloxy radicals; and germanyl radicals of the formula Ge—(R)₃ wherein R is as defined above.

20. The polyolefin composition according to claim 19, wherein in said catalyst Y is independently selected from the group consisting of a hydrogen atom; a halogen atom, a C₁₋₁₀ hydrocarbyl radical; a C₁₋₁₀ alkoxy radical; a C₅₋₁₀ aryl oxide radical; each of which said hydrocarbyl, alkoxy, and aryl oxide radicals may be unsubstituted by or further substituted by one or more substituents selected from the group consisting of a halogen atom; a C₁₋₈ alkyl radical; a C₁₋₈ alkoxy radical; a C₆₋₁₀ aryl or aryloxy radical; an amido radical which is unsubstituted or substituted by up to two C₁₋₈ alkyl radicals; and a phosphido radical which is unsubstituted or substituted by up to two C₁₋₈ alkyl radicals.

21. The polyolefin composition according to claim 20, wherein the cyclopentadienyl ligand is independently selected from the group consisting of a cyclopentadienyl radical, an indenyl radical and a fluorenyl radical.

22. The polyolefin composition according to 21, wherein in said catalyst Y is independently selected from the group consisting of a hydrogen atom, a chlorine atom and a C₁₋₄ alkyl radical.

23. The polyolefin composition according to 22 wherein the bulky heteroatom ligand is selected from the group consisting of phosphinimine ligands, ketimide ligands, silicon-containing heteroatom ligands, amido ligands, alkoxy ligands, boron heterocyclic ligands and phosphole ligands.

24. The polyolefin composition according to claim 23, wherein the phosphinimine ligand has the formula ((R²¹)₃P═N)— wherein each R²¹ is independently selected from the group consisting of C₃₋₆ alkyl radicals which are unsubstituted or substituted by a heteroatom.

25. The polyolefin composition according to claim 8, prepared by molding the composition using a process which can form three dimensional shaped objects without more than a 30% attrition of the length of the fiber.
